(19) United States
(12) Patent Application Publication
(10) Pub. No.: US 2021/0408599 A1
(43) Pub. Date: Dec. 30, 2021

(54) ACHIEVING SAFE AND STABLE ANODES FOR LI ION, LI-S AND LI-AIR BATTERIES: ENHANCED LI+-SOLVENT COORDINATION IN ELECTROLYTES

(71) Applicant: KING ABDULLAH UNIVERSITY OF SCIENCE AND TECHNOLOGY, Thuwal (SA)

(72) Inventors: Lain-Jong LI, Thuwal (SA); Jun MING, Thuwal (SA)

(21) Appl. No.: 16/497,486

(22) PCT Filed: Mar. 30, 2018
(86) PCT No.: PCT/IB2018/052237

§ 371 Date: Sep. 25, 2019

Related U.S. Application Data
(60) Provisional application No. 62/483,045, filed on Apr. 7, 2017.
(60) Provisional application No. 62/624,167, filed on Jan. 31, 2018.

(51) Int. Cl. H01M 10/0568; H01M 10/0525; H01M 10/0569; H01M 4/583; H01M 4/133; H01M 4/38; H01M 50/10

(52) U.S. Cl. CPC H01M 10/0568; H01M 10/0525; H01M 10/0569; H01M 2300/0028; H01M 4/133; H01M 4/38; H01M 50/10; H01M 4/583

(57) ABSTRACT

Lithium batteries, electrolytes configured for use in lithium batteries, and methods of preparing stable lithium batteries are provided. The electrolyte includes a lithium ion source, an ether-based solvent, and an inorganic salt represented by the formula MA, wherein M is selected from the group consisting of Li⁺, Na⁺, K⁺, Ca²⁺, Mg²⁺, and Al³⁺, and A is selected from the group consisting of F⁻, Cl⁻, Br⁻, I⁻, NO₃⁻, SO₄²⁻, CO₃²⁻, and PO₄³⁻. In this regard, the inorganic salt provides coordination cores for lithium ion aggregation.

### CROSS-REFERENCE TO RELATED APPLICATIONS

This application claims priority to U.S. Patent Application No. 62/483,045 filed Apr. 7, 2017, and U.S. Patent Application No. 62/624,167 filed Jan. 31, 2018, which are incorporated by reference herein in their entirety.

### TECHNICAL FIELD

The presently-disclosed invention relates generally to providing safe and stable anodes for various lithium batteries, and more particularly to lithium batteries, electrolytes configured for use in lithium batteries, and methods of preparing stable lithium batteries.

### BACKGROUND

The use of aggressive Li metal anodes in lithium ion batteries typically results in the formation of dendrites with the battery cycling, causing serious safety issues and hindering commercialization. Graphite is known to exhibit the reversible storage capability of lithium ions (Li⁺), and it has been predominantly adopted as an anode in commercial Li-ion batteries since 1991 because it is much safer than using a metallic Li anode. However, only very few carbonate-based solvents such as ethyl carbonate (EC) and dimethyl carbonate (DMC) allow reversible Li⁺ (de-)intercalation in graphite, even though numerous advances have been made in seeking new electrolyte components. To date, insoluble solid electrolyte interphases (SEI) have commonly been used to stabilize graphite anodes in lithium-ion, lithium-S and lithium-air batteries. However, such SEI materials alone are unable to guarantee reversible Li⁺ (de-)intercalation in graphite.

Accordingly, there still exists a need for resolving the poor compatibility of graphite and other electrolyte solvents such as ether-based solvents for next-generation high capacity and safe Li-ion, Li—S and Li-air batteries.

### BRIEF SUMMARY OF THE INVENTION

One or more embodiments of the invention may address one or more of the aforementioned problems. Certain embodiments provide electrolytes, lithium batteries, and methods of preparing stable lithium batteries. In one aspect, an electrolyte configured for use in a lithium battery is provided. The electrolyte may include a lithium ion source, an electrolyte solvent, and an inorganic salt represented by the formula MA, such that M is selected from the group consisting of Li⁺, Na⁺, K⁺, Ca²⁺, Mg²⁺, and Al³⁺, and A is selected from the group consisting of F⁻, Cl⁻, Br⁻, I⁻, NO₃⁻, SO₄²⁻, CO₃²⁻, and PO₄³⁻. The inorganic salt may provide coordination cores for lithium ion aggregation.

In another aspect, a lithium battery is provided. The lithium battery may include a cathode, a carbon-based anode, and an electrolyte. The electrolyte may include a lithium ion source, an electrolyte solvent, and an inorganic salt represented by the formula MA, such that M is selected from the group consisting of Li⁺, Na⁺, K⁺, Ca²⁺, Mg²⁺, and Al³⁺, and A is selected from the group consisting of F⁻, Cl⁻, Br⁻, I⁻, NO₃⁻, SO₄²⁻, CO₃²⁻, and PO₄³⁻. The inorganic salt may provide coordination cores for lithium ion aggregation.

In yet another aspect, a method of preparing stable lithium batteries is provided. The method may include disposing a cathode in a housing, disposing a carbon-based anode in the battery housing in fixed relation to the cathode, and disposing an electrolyte in the battery housing between the cathode and the anode. The electrolyte may include a lithium ion source, an electrolyte solvent, and an inorganic salt represented by the formula MA, such that M is selected from the group consisting of Li⁺, Na⁺, K⁺, Ca²⁺, Mg²⁺, and Al³⁺, and A is selected from the group consisting of F⁻, Cl⁻, Br, I, NO₃, SO₄²⁻, CO₃², and PO₄³⁻. The inorganic salt may provide coordination cores for lithium ion aggregation.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a lithium battery in accordance with certain embodiments of the invention;

FIG. 2 illustrates an examination of the solid electrolyte interphase (SEI) in various solvents, in accordance with certain embodiments of the invention;

FIG. 3 illustrates the effect of lithium salt inhibiting Li⁺-solvent intercalation, in accordance with certain embodiments of the invention;

FIG. 4 illustrates coordination chemistry of lithium salts and solvents, in accordance with certain embodiments of the invention;

FIG. 5 illustrates features of a safer lithium-ion sulfur battery, in accordance with certain embodiments of the invention;

FIG. 6 includes scanning electron microscope (SEM) images of graphite electrodes exposed to various conditions in accordance with certain embodiments of the invention;

FIG. 7 illustrates the SEI effect for graphite in carbonate and ether-based electrolytes in accordance with certain embodiments of the invention;

FIG. 8 illustrates the SEI effect for graphite in ether-based electrolytes at various concentrations in accordance with certain embodiments of the invention;

FIG. 9 illustrates the SEI effect for graphite using a film-forming additive in accordance with certain embodiments of the invention;

FIG. 10 illustrates the effects of lithium salt and/or solvent for Li⁺ (de-)intercalation in graphite in accordance with certain embodiments of the invention; and

FIG. 11 is a schematic block diagram illustrating a method of preparing a stable lithium battery in accordance with certain embodiments of the invention.

### DETAILED DESCRIPTION

The invention now will be described more fully hereinafter with reference to the accompanying drawings, in which some, but not all embodiments of the inventions are shown. Indeed, this inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

As previously discussed herein, intentionally formed insoluble SEI materials on graphite alone are unable to guarantee reversible Li⁺ (de-)intercalation in graphite. Instead, through applied effort, ingenuity, and innovation, the inventors have determined that the coordination structures between Li⁺ ions and solvents/electrolytes determine the graphite anode stability. In particular, the insertion of Li⁺ ions (e.g., for energy storage) and Li⁺-ether clusters (resulting in graphite exfoliation) are in competition, and the unwanted insertion of Li⁺-ether clusters may be inhibited by enhancing the coordination between lithium salts and ether solvents. In this regard, an increase in concentration of a lithium ion source (e.g., organic lithium salt) may suppress the co-insertion of Li⁺ and solvent into graphite, inhibiting the Li battery failure. Inorganic salts such as LiNO₃, NaNO₃, Li₂SO₄ and so on are able to offer coordination cores (i.e. the cationic center which can be connected with solvent molecules) for the Li⁺ aggregation and more efficiently capture Li⁺ from the ether molecules in order to inhibit the Li⁺-solvent co-intercalation into graphite.

In this regard, the coordination chemistry of electrolytes is more critical than the commonly believed SEI in stabilizing the graphite for the reversible Li⁺ (de-)intercalation. The importance of Li⁺ solvation structure, varied by the concentration of lithium salts and the type of solvent, is confirmed in the electrochemical behaviors of graphite anodes. Particularly, LiNO₃, which provides more coordination cores to solvents, greatly helps to form large coordination aggregates, and efficiently reduces the Li⁺-solvent co-intercalation into graphite. As a result, a newly-designed principle for ether-based electrolytes available for graphite to store Li⁺ is presented that enables the construction of reliable and high performance Li-ion, Li—S and Li-air full batteries.

I. Electrolyte for Lithium Battery

In accordance with certain embodiments of the invention, solid or non-aqueous electrolytes configured for use in a lithium battery are provided. The electrolyte includes a lithium ion source (e.g., organic lithium salt), an electrolyte solvent, and an inorganic salt represented by the formula MA, wherein M is selected from the group consisting of Li⁺, Na⁺, K⁺, Ca²⁺, Mg²⁺, and Al³⁺, and A is selected from the group consisting of F⁻, Cl⁻, Br⁻, I⁻ NO₃, SO₄²⁻, CO₃²⁻, and PO₄³⁻. In this regard, the inorganic salt may provide coordination cores (i.e. the cationic center which can be connected with solvent molecules) for Li⁺ ion aggregation and, as a result, more efficiently captures Li⁺ ions from ether molecules in the electrolyte solvent, reduces the strength of the Li⁺-solvent, and inhibits Li⁺-solvent co-intercalation into graphite.

In accordance with certain embodiments, for example, the electrolyte may be configured for use in a lithium-ion battery, a lithium-sulfur battery, or a lithium-air battery. In some embodiments, for instance, the electrolyte may be configured for use in a lithium battery having a carbon-based anode. In further embodiments, for example, the carbon-based anode may comprise graphite.

In accordance with certain embodiments, for instance, the lithium ion source may comprise at least one of a phosphate (e.g., LiPF₆), a borate or boron-based cluster (e.g., LiBF₄, lithium pentafluoroethyltrifluoroborate (LiFAB), lithium (malonatooxalato) borate (LiMOB)), an imide (e.g., LiN(SO₂CF₃)₂(“LiTFSI”), lithium (fluorosulfonyl) (nonafluorobutanesulfonyl) imide (LiFNFSI)), a heterocyclic anion (e.g., lithium bis(trifluoroborane) imidazolide (LiIm(BF₃)₂), lithium 1,2,3-triazole-4,5-dicarbonitrile (LiTADC)), an aluminate (e.g., lithium tetra(1,1,1,3,3,3-hexafluoro-2-propyl) aluminate (LiAl[OCH(CF₃)₂]₄), or any combination thereof. In some embodiments, for example, the electrolyte may comprise a lithium ion source concentration of 1.0 to 3.5 M. As such, in certain embodiments, the electrolyte may comprise a lithium ion source concentration of at least about any of the following: 1.0, 1.5, 2.0, 2.5, 3.0, and 3.5 M and/or at most about 3.5, 3.0, 2.5, 2.0, 1.5, and 1.0 M (e.g., about 1.5-3.5 M, about 1.0-2.5 M, etc.).

According to certain embodiments, for instance, the inorganic salt may comprise at least one of a nitrate salt, a sulfate salt, a phosphate salt, a carbonate salt, or any combination thereof dissolved in solvent. In some embodiments, for example, the inorganic salt may comprise at least one of LiNO₃, NaNO₃, Li₂SO₄, or any combination thereof. In further embodiments, for instance, the electrolyte may comprise an inorganic salt concentration of 0.4 to 1.5 M. As such, in certain embodiments, the electrolyte may comprise an inorganic salt concentration of at least about any of the following: 0.4, 0.5, 0.6, 0.7, 0.8, 0.9, 1.0, 1.1, 1.2, 1.3, 1.4, and 1.5 M and/or at most about 1.5, 1.4, 1.3, 1.2, 1.1, 1.0, 0.9, 0.8, 0.7, 0.6, 0.5, and 0.4 M (e.g., about 0.6-1.5 M, about 0.4-1.0 M, etc.).

According to certain embodiments, for example, the electrolyte solvent may comprise an ether-based solvent, a sulfone, a sulfoxide nitrile, a phosphorous-based solvent, a silicon-based solvent, or any combination thereof. In some embodiments, for instance, the ether-based solvent may comprise at least one of dioxolane (DOL), dimethoxyethane (DME), tetrahydrofuran (THF), diethyl ether, tetraethylene glycol dimethyl ether (TEGDME), or any combination thereof. In further embodiments, for instance, the ether-based solvent may comprise only DOL. In other embodiments, for example, the ether-based solvent may comprise a mixture of DOL and DME. In further embodiments, for instance, the ether-based solvent may comprise DOL and DME in a 1:1 ratio by volume.

According to certain embodiments, for example, the electrolyte may comprise the same concentration of lithium ion source and inorganic salt. In other embodiments, for instance, the electrolyte may comprise a larger concentration of lithium ion source than inorganic salt. In this regard, for example, the ratio of lithium ion source to inorganic salt may be from about 1 to about 8.75. For example, in some embodiments, the electrolyte may comprise 2.5 M lithium ion source and 0.4 M inorganic salt. In other embodiments, for instance, the electrolyte may comprise 1.0 M lithium ion source and 0.4 M inorganic salt. In further embodiments, for example, the electrolyte may comprise 1.5 M lithium ion source and 1.5 M inorganic salt.

In this regard, in certain embodiments, for instance, the lithium ion source may comprise 2.5 M LiTFSI, the ether-based solvent may comprise DOL and DME, and the inorganic salt may comprise 0.4 M LiNO₃. In other embodiments, for example, the lithium ion source may comprise 1.0 M LiTFSI, the ether-based solvent may comprise DOL, and the inorganic salt may comprise 0.4 M LiNO₃. In further embodiments, for instance, the lithium ion source may comprise 1.5 M LiTFSI, the ether-based solvent may comprise DOL and DME, and the inorganic salt may comprise 1.5 M LiNO₃.

II. Lithium Battery

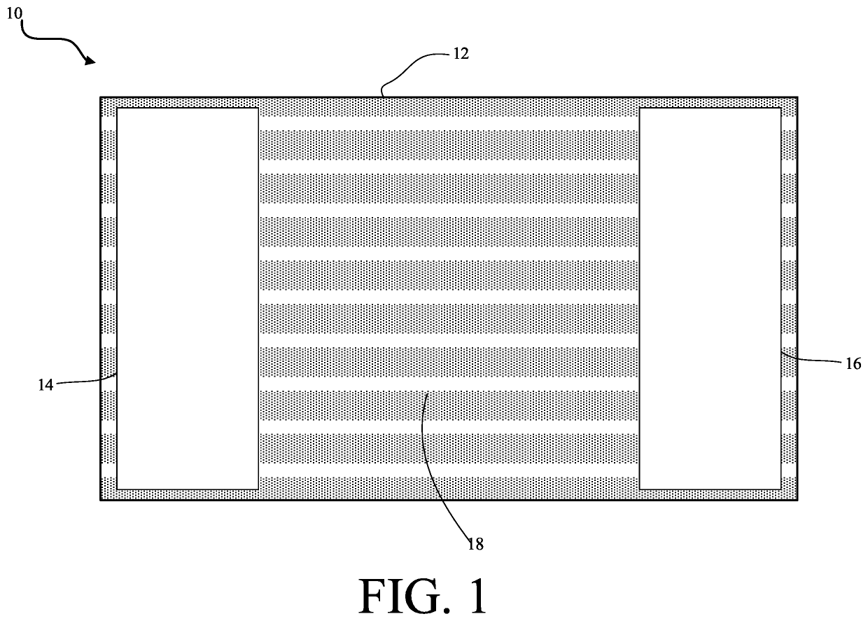

In another aspect, lithium batteries are provided. FIG. 1, for example, illustrates a lithium battery in accordance with certain embodiments of the invention. As shown in FIG. 1, the lithium battery 10 includes a battery housing 12, a cathode 14 (i.e. positive electrode), a carbon-based anode 16 (i.e. negative electrode), and an electrolyte 18. The electrolyte includes a lithium ion source (e.g., organic lithium salt), an ether-based solvent, and an inorganic salt represented by the formula MA, wherein M is selected from the group consisting of Li⁺, Na⁺, K⁺, Ca²⁺, Mg²⁺, and Al³⁺, and A is selected from the group consisting of F⁻, Cl⁻, Br⁻, I⁻, NO₃, SO₄²⁻, CO₃²⁻, and PO₄³⁻, as discussed previously herein.

In accordance with certain embodiments, for example, the lithium battery may comprise a lithium-ion battery, a lithium-sulfur battery, lithium-air battery. In some embodiments, for instance, the cathode may be a lithium-based cathode (e.g., in a lithium-ion battery). For example, in certain embodiments, the cathode may comprise at least one of LiNiₓCo_{y}Mn_{z}O₂ (x+y+z=1), LiFeₓCo_{y}Mn_{z}PO₄ (x+y+z=1), LiNiₓCo_{y}Mn_{2-x-y}O₄ (x+y≤2), mLi₂MnO₃.nLiNiₓCo_{y}Mn_{z}O₂ (x+y+z=1)₂, LiNiₓCo_{y}Mn_{z}MₜO₂ (m+n=1; x+y+z+t=1, M=Fe, Al, Ti, Mg, Ca, Zr, V, Cu, Zn, Cr), Li₄Ti₅O₁₂, or any combination thereof. In other embodiments, for instance, the cathode may comprise sulfur (e.g., in a lithium-sulfur battery). In still other embodiments, for example, the cathode may comprise oxygen (e.g., in a lithium-air battery).

According to certain embodiments, for example, the carbon-based anode may comprise graphite, hard carbon, mesophase microbeads, or any combination thereof. The electrolytes discussed herein work with the graphite anode such that the coordination structures between the Li⁺ ions and the solvent/electrolyte determines the stability of the graphite anode. Without being limited by theory, the increase in the lithium ion source (e.g., organic lithium salt) may suppress the co-insertion of Li⁺ ions and solvent into graphite, preventing lithium battery failure. In particular, the inorganic salt (e.g., LiNO₃, NaNO₃, Li₂SO₄, etc.) may provide coordination cores for Li⁺ ion aggregation to more efficiently capture Li⁺ ions from ether molecules in the solvent, thereby inhibiting the Li⁺-solvent co-intercalation into graphite. In this regard, the addition of an inorganic salt (e.g., LiNO₃) may considerably help form these desired coordination structures while reducing the concentration of the lithium ion source (e.g., LiTFSI) in the electrolyte.

III. Method of Preparing Stable Lithium Battery

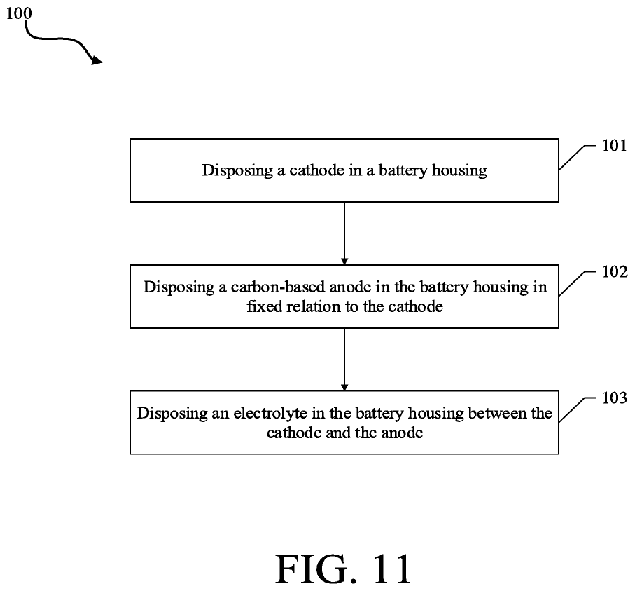

In yet another aspect, methods of preparing stable lithium batteries are provided. As shown in FIG. 11, the method 100 includes disposing a cathode in a battery housing at block 101, disposing a carbon-based anode in the battery housing in fixed relation to the cathode in block 102, and disposing an electrolyte in the battery housing between the cathode and the anode in block 103. The electrolyte includes a lithium ion source (e.g., organic lithium salt), an ether-based solvent, and an inorganic salt represented by the formula MA, wherein M is selected from the group consisting of Li⁺, Na⁺, K⁺, Ca²⁺, Mg²⁺, and Al³⁺, and A is selected from the group consisting of F⁻, Cl⁻, Br, I, NO₃⁻, SO₄², CO₃²⁻, and PO₄³⁻, as discussed previously herein.

According to certain embodiments, the anode and cathode may be disposed within the battery housing in any suitable configuration as understood by one of ordinary skill in the art. For example, the anode and cathode may comprise wires, wire coils, wire coils placed in tubes, plates, or any other suitable configuration as understood by one of ordinary skill in the art as long as the anode and cathode are spaced apart such that the electrolyte is present between them.

### EXAMPLES

The following examples are provided for illustrating one or more embodiments of the present invention and should not be construed as limiting the invention.

### Example 1: Examination of Solid Electrolyte Interphase (SEI) in Various Solvents

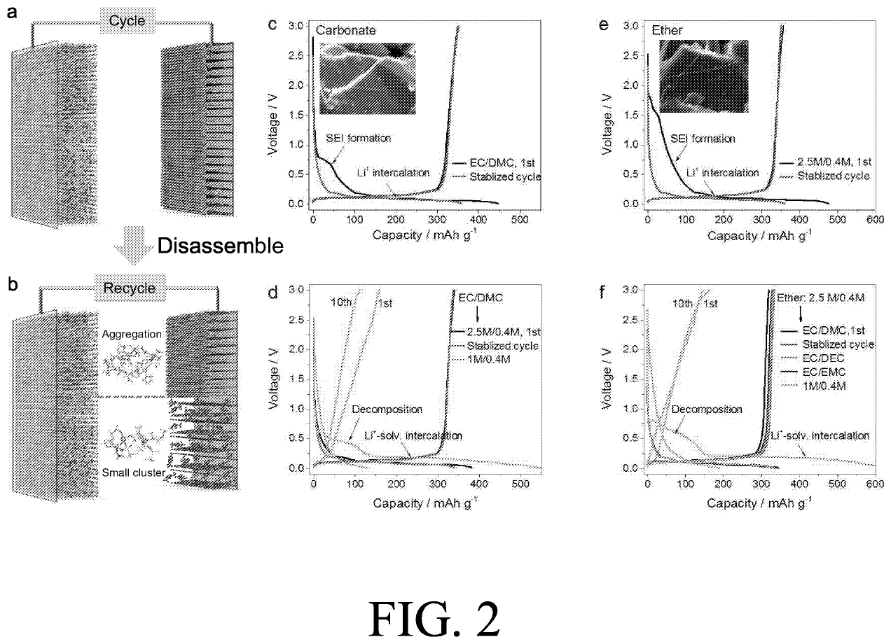

The role of SEI formed on graphite surfaces was examined by disassembling a stabilized electrode from a battery and then recycled using different kinds of electrolyte, as shown in FIGS. 2a and 2b. FIG. 2c illustrates the voltage versus capacity profiles of pristine graphite cycled in a half battery (lithium metal versus graphite anode) with a commercial carbonate-based electrolyte, 1.0 M LiPF₆ in ethyl carbonate/dimethyl carbonate (EC/DMC; v/v=1/1). The 1st discharge curve indicates the formation of SEI followed by Li⁺ intercalation into graphite. The graphite is stabilized in the 2nd cycle, which is usually attributed to SEI protection.

The stabilized graphite protected with SEI coatings was disassembled and cycled in an ether-based electrolyte (1.0 M LiTFSI, 0.4 M LiNO3 in dioxolane/dimethoxyethane (DOL/DME; v/v=1/1); abbreviated as 1.0 M/0.4 M). Serious electrolyte decomposition and Li⁺-solvent intercalation occurred immediately, and the capacity dropped rapidly with cycling. However, when the same SEI-coated graphite was cycled in one of the electrolytes in accordance with certain embodiments previously discussed herein (e.g., 2.5 M LiTFSI/0.4 M LiNO3 in DOL/DME, abbreviated as 2.5 M/0.4 M), a stable cycle performance was maintained without obvious electrolyte decomposition, as shown in FIG. 2d. These results suggest that the SEI formed in the carbonate-based electrolyte cannot inhibit the electrolyte decomposition and Li⁺-solvent intercalation once a dilute ether-based solution is used. A separate experiment revealed that the graphite stably cycled in 2.5 M/0.4 M does not show stable cycle performance in the electrolyte of 1.0 M/0. 4M (FIGS. 2c, 2d), even when the SEI is formed in the same type of electrolytes and solvents (inset of FIG. 2c). In contrast, the disassembled electrode cycled well in varied carbonate electrolytes with negligible electrolyte-decomposition phenomena, as shown in FIGS. 2e and 2f. All these observations indicate that the graphite surface protection offered by SEI could be very limited, and the electrolyte-solvent coordination structure (i.e. the status of Li⁺-solvent interaction and the aggregation of Li⁺-solvent clusters) is the key to the reversibility of Li⁺ (de-)intercalation.

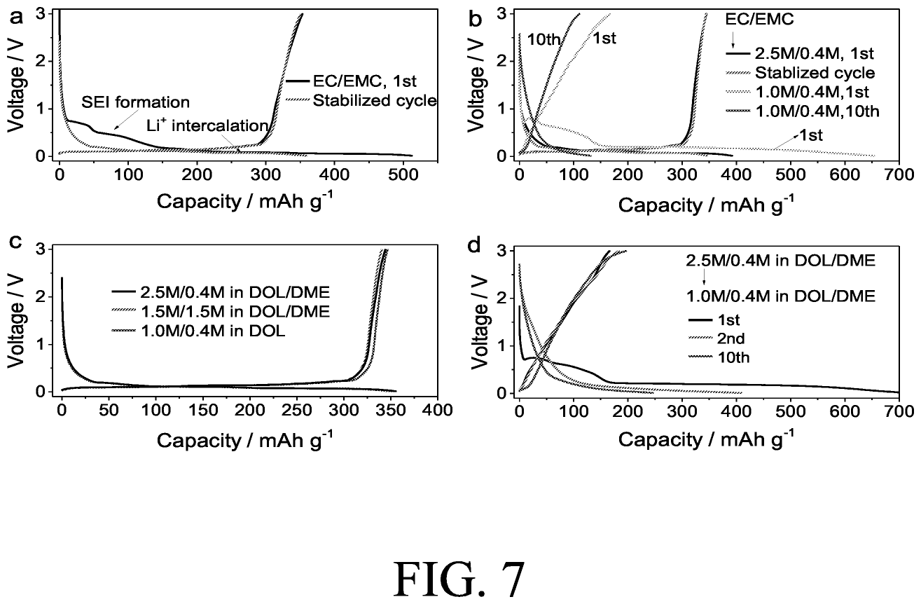

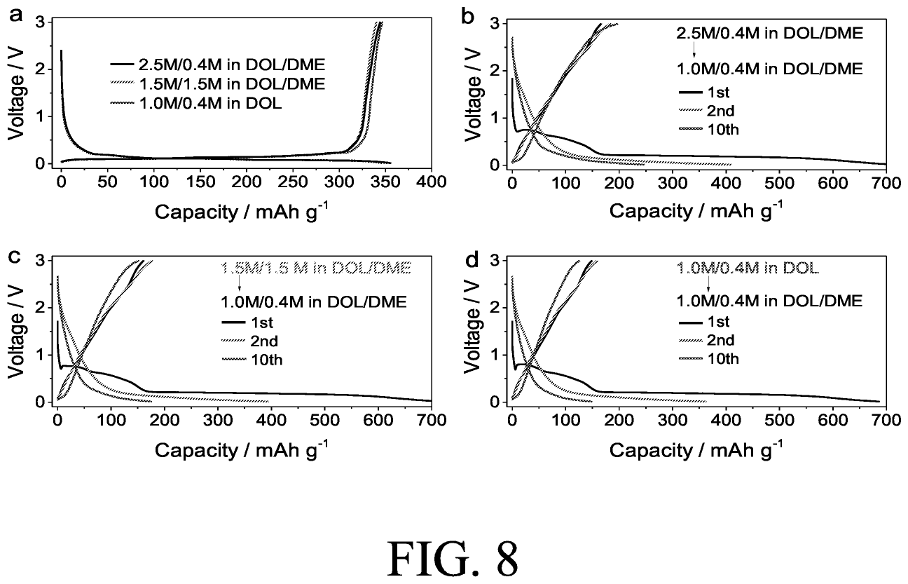

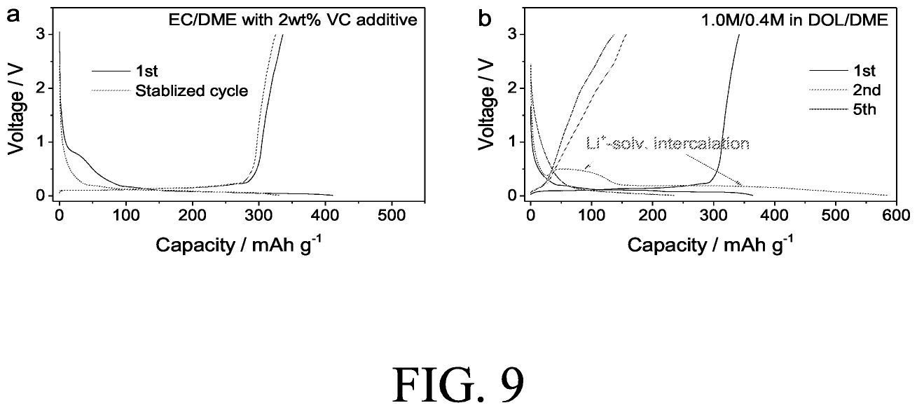

As shown in FIGS. 7 and 8, these results were further verified by testing different carbonate solvents and ether-based electrolytes. For example, FIG. 7a shows the voltage versus capacity profiles of pristine graphite cycled in a carbonate-based electrolyte of 1.0 M LiPF₆ in ethylene carbonate/diethyl carbonate (EC/DEC, v/v=1:1). FIG. 7b illustrates the graphite of FIG. 7a recycled in ether-based electrolytes using different concentrations of lithium ion source. FIG. 7c shows the voltage versus capacity profiles of pristine graphite cycled in a carbonate-based electrolyte of 1.0 M LiPF₆ in ethylene carbonate/ethyl methyl carbonate (EC/EMC, v/v=1:1). FIG. 7d illustrates the graphite of FIG. 7c recycled in ether-based electrolytes using different concentrations of lithium salt. Moreover, FIG. 8a shows the stabilized voltage versus capacity profiles of pristine graphite cycled in the ether-based electrodes in accordance with certain embodiments previously discussed herein. These electrolytes were available for the (de-)intercalation of Li⁺ ions within the graphite. A SEI is formed on the graphite surface, as further shown in FIG. 9. FIGS. 8b, 8c, and 8d illustrate the battery of FIG. 8a disassembled and the stabilized graphite recycled in a dilute electrolyte of 1.0 M/0.4 M in DOL/DME. Again, electrolyte-deposition and Li⁺-solvent co-intercalation occurred regardless of which kind of electrolyte was used initially. As such, the SEI cannot protect the graphite once the dilute electrolyte was used. In this regard, the Li⁺-electrolyte coordination is more critical than the SEI to achieve reversible Li⁺ (de-)intercalation within graphite.

FIG. 9 further illustrates that the electrolyte with added vinylene carbonate, known to form a protective layer on graphite anodes, still cannot achieve stable cycling in electrolytes of 1.0 M/0.4 M. For example, FIG. 9a illustrates the stabilized voltage versus capacity profiles of pristine graphite cycled in 1.0 M LiPF₆ EC/DMC with 2 wt % vinylene carbonate (VC). FIG. 9b shows the battery of FIG. 9a disassembled and the stabilized graphite recycled in a dilute electrolyte of 1.0 M/0.4 M in DOL/DME. The solid SEI only protected the graphite for only one cycle, followed by serious electrolyte-deposition and Li⁺-solvent co-intercalation. As such, the SEI cannot protect the graphite once the dilute electrolyte was used. In this regard, the Li⁺-electrolyte coordination is more critical than the SEI to achieve reversible Li⁺ (de-)intercalation within graphite.

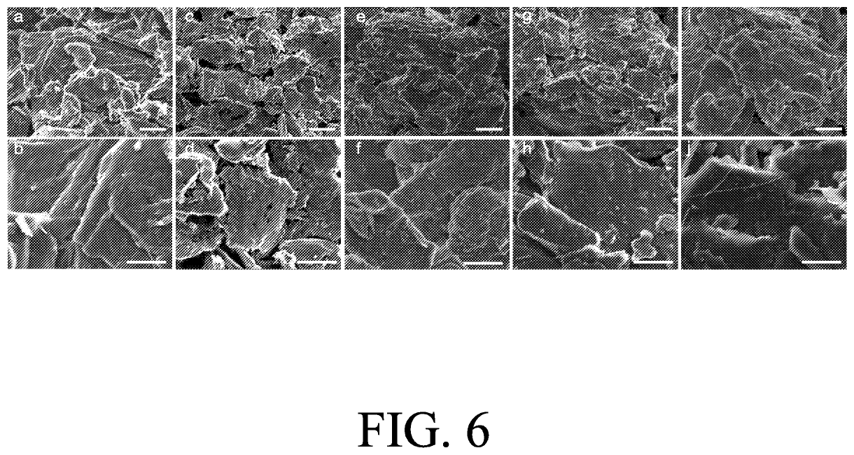

SEM images of graphite electrodes exposed to various testing conditions are shown in FIG. 6. For example FIGS. 6a and 6b show a pristine graphite electrode, FIGS. 6c and 6d show a graphite electrode cycled in a carbonate-based electrolyte of 1.0 M LiPF₆ in ethylene carbonate/dimethyl carbonate (EC/DMC, v/v=1:1), FIGS. 6e and 6f show a graphite electrode cycled in a carbonate-based electrolyte of 1.0 M LiPF₆ in ethylene carbonate/diethyl carbonate (EC/DEC, v/v=1:1), FIGS. 6g and 6h show a graphite electrode cycled in a carbonate-based electrolyte of 1.0 M LiPF₆ in ethylene carbonate/ethyl methyl carbonate (EC/EMC, v/v=1:1), and FIGS. 6i and 6j show a graphite electrode cycled in an ether-based electrode of 2.5 M LiTFSI and 0.4 M LiNO₃ in dioxolane/dimethoxyethane (DOL/DME; v/v=1:1). The scale bar of FIGS. 6a, 6c, 6e, 6g, and 6i is 5 μm, and the scale bar of FIGS. 6b, 6d, 6f, 6h, and 6j is 2 μm.

### Example 2: Effects of Lithium Salt Inhibiting Li⁺-Solvent Intercalation

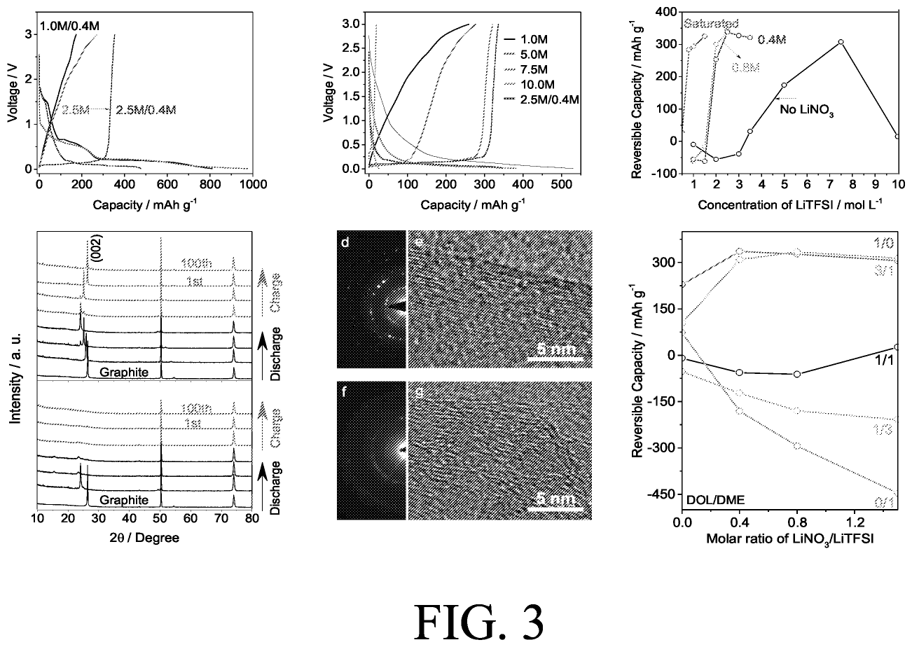

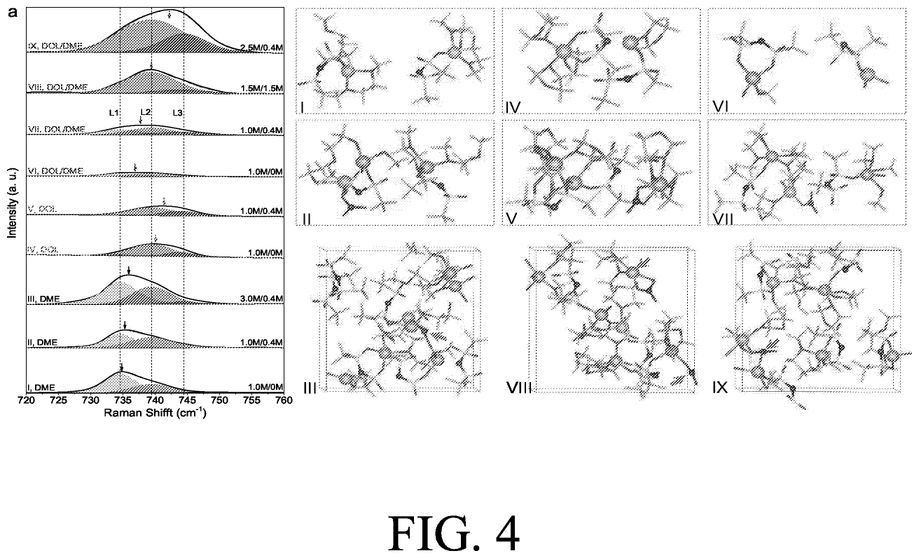

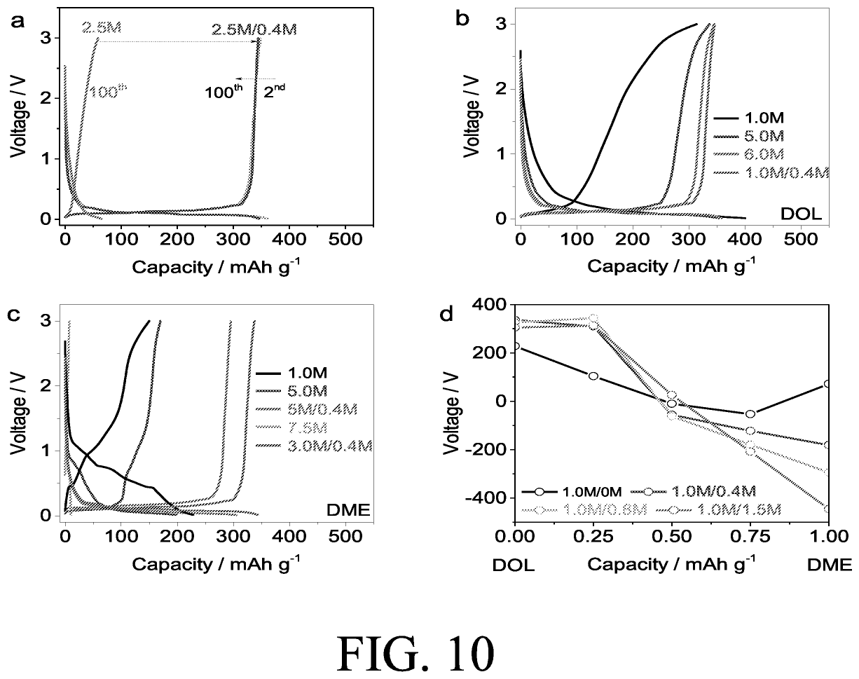

FIG. 3a shows that the graphite cycled in 2.5 M/0.4 M displays an ideal (dis-)charge profile, and FIG. 10a shows that such graphite maintains excellent reversibility. However, the graphite cycled in 1.0 M/0.4 M or 2.5 M/0 M (2.5 M LiTFSI without LiNO₃) shows obvious tailing expanding from 230 to 800 mAh g⁻¹ in the first discharge with the capacity decaying fast (as shown in FIG. 4a), attributed to the Li⁺-solvent co-intercalation and graphite exfoliation. As shown in FIG. 3b, the recoverable layered structure of graphite in 2.5 M/0.4 M is demonstrated by ex-situ X-ray diffraction patterns (XRD), even over one hundred cycles. In contrast, for the graphite cycled in 1.0 M/0.4 M or 2.5 M/0 M, the (002) peak corresponding to the layered structure of graphite disappeared fast after an obvious expansion in the first discharge and never appeared again, as shown in FIG. 3c. The selected area electron diffraction (SAED) and high-resolution transmission electron microscopy (HRTEM) results shown in FIGS. 2d-2g also support the fine crystallinity of cycled graphite in 2.5 M/0.4 M over that in 1.0 M/0.4 M. The completely different behaviors of graphite in varied concentrations of LiTFSI/LiNO₃ demonstrates the great effect of lithium salt inhibiting the Li⁺-solvent co-intercalation. These results suggest that the LiNO₃ is the most critical factor for controlling the Li⁺ intercalation.

FIG. 3d demonstrates the interplay of lithium salt on graphite capacity, and the dominant role of LiNO₃ is summarized as follows. Without LiNO₃, an extremely high concentration of LiTFSI (7.5 M in DOL/DME or 6.0 M in pure DOL) is needed for inhibiting the Li⁺-solvent co-intercalation and graphite exfoliation (FIG. 3h, FIG. 10b). However, it was not possible to inhibit the graphite exfoliation if only DME was used as a solvent even it contained 10.0 M LiTFSI (FIG. 10c). The addition of 0.4 M LiNO₃ was able to greatly reduce the required LiTFSI concentration to 1.0 M in DOL or 2.5 M in DOL/DME respectively, and further increasing the LiNO₃ concentration to saturation (e.g., 1.5 M) ensured the reversible Li⁺ intercalation at concentrations of LiTFSI as low as 1.0-1.5 M in DOL/DME. At a concentration of 1.0 M LiTFSI, the effect of LiNO₃ was drastically different in DOL and DME. The LiNO₃ was helpful to stabilize the graphite only in DOL-dominated solution (DOL, ≥50% in volume), but it showed a negative effect in a DME-dominated system (FIG. 10d), which was further confirmed by varying the molar ratio of LiNO₃/LiTFSI (FIG. 3j).

### Example 3: Coordination of Lithium Salts and Solvents

The graphite stability in various solutions was interpreted with the coordination structure of lithium salts and solvents. The Raman S—N—S vibration spectra of TFSI⁻ for the selected electrolyte compositions and the corresponding structures obtained from a molecular dynamics (MD) simulation are shown in FIG. 4. In DME, the Li⁺ ions from LiTFSI were solvated fully by DME or partly monodentate-chelated (loosely bonded) to TFSI⁻, which was evidenced by the softening of the S—N—S Raman bending mode from 734.5 cm⁻¹ (LiTFSI crystal) to 739.5 cm⁻¹ (weak interaction between Li⁺ and TFSI⁻). Increasing LiTFSI concentration or adding LiNO₃ respectively did not obviously change the situation because the solvation of Li⁺ by DME was preferred (solvation energy 974.96 meV). Therefore, the intercalation of Li⁺-DME clusters into graphite always led to the observed graphite exfoliation. To enable the DME-based electrolyte to work, a relatively high concentration of LiTFSI over 3.0 M, and the presence of LiNO₃ was necessary for a large aggregation, such as 3.0 M/0.4 M in DME.

In clear contrast, LiTFSI was not well-solvated in DOL due to the weak solvation energy of DOL with Li⁺ (564.17 meV). The Li⁺ ions formed monodentate- and bidentate-chelated clusters with TFSI⁻, suggesting the strong interaction between Li⁺ and TFSI⁻. Hence, the S—N—S bending frequency mainly around 739.5 cm⁻¹/744.5 cm⁻¹ was higher than that in DME (FIG. 4). However, there was still a certain amount of Li⁺-DOL clusters (or Li⁺ loosely bonded to TFSI⁻), which can be co-intercalated into graphite and result in exfoliation. The addition of 0.4 M LiNO₃ actually allowed the DOL solvents to be captured by NO₃⁻, reducing the number of Li⁺-DOL clusters and increasing the bidentate-chelated Li⁺-TFSI⁻ structures (FIG. 4). Meanwhile these bidentate structures were further stabilized with Li⁺ NO₃⁻ by forming large aggregates, thereby allowing only reversible Li⁺ insertion rather than co-intercalation of large aggregates. A large aggregation structure could be also achieved simply by increasing the LiTFSI concentration up to 6.0 M in pure DOL, which would guarantee the reversible Li⁺ (de-)intercalation in graphite but is not recommended considering the cost and inferior performance. Clearly, the LiNO₃ solute exhibited the great advantage of reducing the required LiTFSI concentration to enhance the graphite stability.

In a dual-solvent system of DOL/DME (v/v=1:1), a relatively higher S—N—S bending energy was demonstrated than that in pure DME (FIG. 4) because a close interaction of Li⁺ TFSI⁻ formed due to the higher LiTFSI concentration restrained in the DME solvent, where the half volume of solution was occupied by the DOL with weak solvation power for LiTFSI. However, no matter whether there was LiNO₃ in a dilute solution of 1.0 M LiTFSI, the small cluster of Li⁺-DME always existed and led to the Li⁺-solvent co-intercalation (FIG. 4, VI, VII). Increasing LiNO₃ and/or LiTFSI concentration was essential for a large aggregation of Li⁺-solvent/Li⁺-TFSI⁻. Particularly for the LiNO₃ solute, the unique structure of NO₃⁻ can bond 2-3 Li⁺ ions through 2-3 bridged-oxygens with ether molecules and TFSI⁻, largely facilitating the aggregation and dominant capture of the Li⁺ from the Li⁺-solvent due to the stronger interaction of Li⁺—NO₃⁻ (5,221.82 meV), thereby inhibiting the Li⁺-solvent co-intercalation. Thus, two series of available electrolytes (e.g., 1.5 M/1.5 M or 2.5 M/0.4 M) were designed in a large aggregation (FIG. 4, VIII, IX), where the later-concentrated LiTFSI formed bidentate chelating and then gave rise to the higher bending energy (FIG. 4, IX).

### Example 4: Lithium-Ion Sulfur Battery

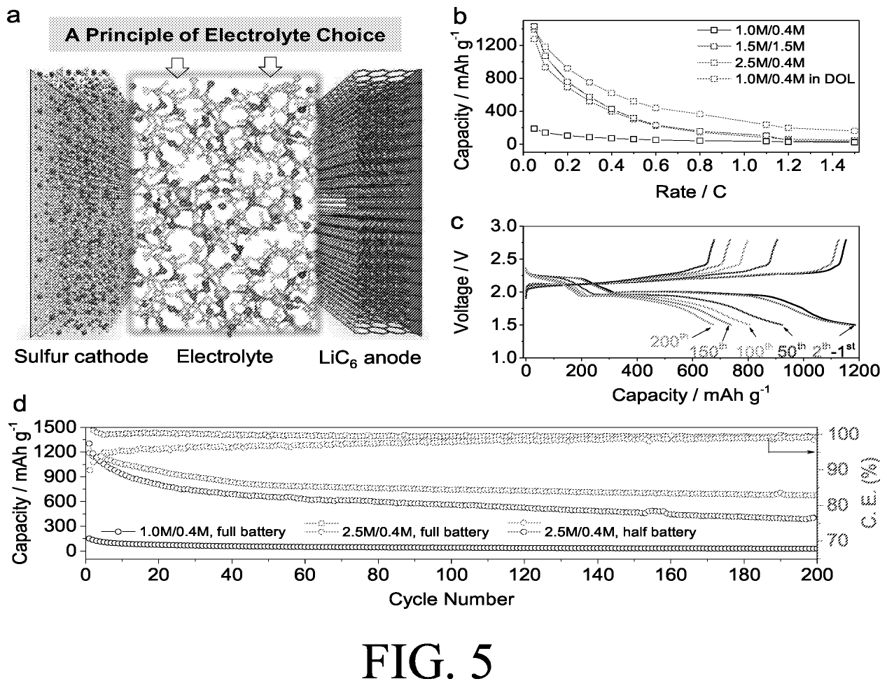

The Li⁺ solvation structures not only determined the graphite anode stability but also largely affected the electrochemical performance of the sulfur cathode in Li—S full batteries. FIG. 5a shows a configuration including a commonly used S cathode, electrolyte (separator), and an anode of Li⁺-intercalated graphite. To stabilize graphite, three electrolytes, including 2.5 M/0.4 M and 1.5 M/1. 5M in DOL/DME and 1.0 M/0.4 M in DOL, were tested and all demonstrated high capacity and rate capability, as shown in FIGS. 5b and 5c. In contrast, the commonly used electrolyte of 1.0 M/0.4 M and other dilute electrolytes led to low capacity and poor cycle performance due to the irreversible Li⁺ storage capability (FIG. 5d). Furthermore, the Li—S battery using the electrolyte of 2.5 M/0.4 M could cycle beyond 200 cycles with an initial capacity of 1200 mAh g⁻¹ at the rate of 0.1 C. Average capacity of 700 mAh g⁻¹ was achieved, and the energy density was as high as 2000 Wh kgs⁻¹. Particularly, the impressive coulombic efficiency around 100% directly confirmed that the layered graphite can act as an ideal host for storing Li⁺ while efficiently avoiding the side-reactions with the migrated polysulfides in electrolyte.

### Non-Limiting Exemplary Embodiments

Having described various aspects and embodiments of the invention herein, further specific embodiments of the invention include those set forth in the following paragraphs.

Certain embodiments provide electrolytes, lithium batteries, and methods of preparing stable lithium batteries. In one aspect, an electrolyte configured for use in a lithium battery is provided. The electrolyte may include a lithium ion source, an electrolyte solvent, and an inorganic salt represented by the formula MA, such that M is selected from the group consisting of Li⁺, Na⁺, K⁺, Ca²⁺, Mg²⁺, and Al³⁺, and A is selected from the group consisting of F⁻, Cl⁻, Br⁻, I⁻, NO₃, SO₄²⁻, CO₃²⁻, and PO₄³⁻. The inorganic salt may provide coordination cores for lithium ion aggregation.

In accordance with certain embodiments, for example, the electrolyte may comprise a lithium ion source concentration of 1.0 to 3.5 M. In some embodiments, for instance, the lithium ion source may comprise at least one of a phosphate, a borate or boron-based cluster, an imide, a heterocyclic anion, an aluminate, or any combination thereof.

In accordance with certain embodiments, for example, the electrolyte may comprise an inorganic salt concentration of 0.4 to 1.5 M. In some embodiments, for instance, the inorganic salt may comprise at least one of a nitrate salt, a sulfate salt, a phosphate salt, a carbonate salt, or any combination thereof. In further embodiments, for example, the inorganic salt may comprise at least one of LiNO₃, NaNO₃, Li₂SO₄, or any combination thereof.

According to certain embodiments, for example, the electrolyte may comprise 2.5 M lithium ion source and 0.4 M inorganic salt. In certain embodiments, for instance, the electrolyte may comprise 1.0 M lithium ion source and 0.4 M inorganic salt. In other embodiments, for example, the electrolyte may comprise 1.5 M lithium ion source and 1.5 M inorganic salt.

In accordance with certain embodiments, for instance, the electrolyte solvent may comprise at least one of an ether-based solvent, a sulfone, a sulfoxide nitrile, a phosphorous-based solvent, a silicon-based solvent, or any combination thereof. In further embodiments, for example, the ether-based solvent may comprise at least one of dioxolane, dimethoxyethane, tetrahydrofuran, diethyl ether, tetraethylene glycol dimethyl ether, or any combination thereof.

In accordance with certain embodiments, for instance, the electrolyte may be configured for use in a lithium-ion battery, a lithium-sulfur battery, or a lithium-air battery. In some embodiments, for example, the electrolyte may be configured for use in a lithium battery having a carbon-based anode. In such embodiments, for instance, the carbon-based anode may comprise at least one of graphite, hard carbon, mesophase microbeads, or any combination thereof.

In accordance with certain embodiments, for example, the lithium ion source salt may comprise 2.5 M LiTFSI, the ether-based solvent may comprise dioxolane and dimethoxyethane, and the inorganic salt may comprise 0.4 M LiNO₃. In other embodiments, for instance, the lithium ion source may comprise 1.0 M LiTFSI, the ether-based solvent may comprise dioxolane, and the inorganic salt may comprise 0.4 M LiNO₃. In further embodiments, for example, the lithium ion source may comprise 1.5 M LiTFSI, the ether-based solvent may comprise dioxolane and dimethoxyethane, and the inorganic salt may comprise 1.5 M LiNO₃.

In accordance with certain embodiments, for instance, the electrolyte may be used in a lithium-ion battery to prevent Li⁺-solvent co-intercalation in graphite. In other embodiments, for example, the electrolyte may be used in a lithium-sulfur battery to prevent Li⁺-solvent co-intercalation in graphite. In further embodiments, for instance, the electrolyte may be used in a lithium-air battery to prevent Li⁺-solvent co-intercalation in graphite.

In another aspect, a lithium battery is provided. The lithium battery may include a cathode, a carbon-based anode, and an electrolyte. The electrolyte may include a lithium ion source, an electrolyte solvent, and an inorganic salt represented by the formula MA, such that M is selected from the group consisting of Li⁺, Na⁺, K⁺, Ca²⁺, Mg²⁺, and Al³⁺, and A is selected from the group consisting of F⁻, Cl⁻, Br⁻, I⁻, NO₃⁻, SO₄²⁻, CO₃²⁻, and PO₄³⁻. The inorganic salt may provide coordination cores for lithium ion aggregation. In some embodiments, for example, the cathode may be a lithium-based cathode. In other embodiments, for instance, the cathode may comprise sulfur. In further embodiments, for example, the cathode may comprise oxygen. In certain embodiments, for instance, the carbon-based anode may comprise at least one of graphite, hard carbon, mesophase microbeads, or any combination thereof. In some embodiments, for example, the electrolyte may be configured for use in a lithium-ion battery, a lithium-sulfur battery, or a lithium-air battery.

In accordance with certain embodiments, for example, the electrolyte may comprise a lithium ion source concentration of 1.0 to 3.5 M. In some embodiments, for instance, the lithium ion source may comprise at least one of a phosphate, a borate or boron-based cluster, an imide, a heterocyclic anion, an aluminate, or any combination thereof.

In accordance with certain embodiments, for example, the electrolyte may comprise an inorganic salt concentration of 0.4 to 1.5 M. In some embodiments, for instance, the inorganic salt may comprise at least one of a nitrate salt, a sulfate salt, a phosphate salt, a carbonate salt, or any combination thereof. In further embodiments, for example, the inorganic salt may comprise at least one of LiNO₃, NaNO₃, Li₂SO₄, or any combination thereof.

According to certain embodiments, for example, the electrolyte may comprise 2.5 M lithium ion source and 0.4 M inorganic salt. In certain embodiments, for instance, the electrolyte may comprise 1.0 M lithium ion source and 0.4 M inorganic salt. In other embodiments, for example, the electrolyte may comprise 1.5 M lithium ion source and 1.5 M inorganic salt.

In accordance with certain embodiments, for instance, the electrolyte solvent may comprise at least one of an ether-based solvent, a sulfone, a sulfoxide nitrile, a phosphorous-based solvent, a silicon-based solvent, or any combination thereof. In further embodiments, for example, the ether-based solvent may comprise at least one of dioxolane, dimethoxyethane, tetrahydrofuran, diethyl ether, tetraethylene glycol dimethyl ether, or any combination thereof.

In accordance with certain embodiments, for example, the lithium ion source salt may comprise 2.5 M LiTFSI, the ether-based solvent may comprise dioxolane and dimethoxyethane, and the inorganic salt may comprise 0.4 M LiNO₃. In other embodiments, for instance, the lithium ion source may comprise 1.0 M LiTFSI, the ether-based solvent may comprise dioxolane, and the inorganic salt may comprise 0.4 M LiNO₃. In further embodiments, for example, the lithium ion source may comprise 1.5 M LiTFSI, the ether-based solvent may comprise dioxolane and dimethoxyethane, and the inorganic salt may comprise 1.5 M LiNO₃.

In yet another aspect, a method of preparing stable lithium batteries is provided. The method may include disposing a cathode in a housing, disposing a carbon-based anode in the battery housing in fixed relation to the cathode, and disposing an electrolyte in the battery housing between the cathode and the anode. The electrolyte may include a lithium ion source, an electrolyte solvent, and an inorganic salt represented by the formula MA, such that M is selected from the group consisting of Li⁺, Na⁺, K⁺, Ca²⁺, Mg²⁺, and Al³⁺, and A is selected from the group consisting of F⁻, Cl⁻, Br, I, NO₃, SO₄², CO₃²⁻, and PO₄³⁻. The inorganic salt may provide coordination cores for lithium ion aggregation. In some embodiments, for example, the electrolyte may be configured for use in a lithium-ion battery, a lithium-sulfur battery, or a lithium-air battery.

In accordance with certain embodiments, for instance, disposing the cathode in the battery housing may comprise disposing a lithium-based cathode in the housing. In other embodiments, for example, disposing the cathode in the battery housing may comprise disposing a cathode comprising sulfur in the housing. In further embodiments, for instance, disposing the cathode in the battery housing may comprise disposing a cathode comprising oxygen in the housing. In some embodiments, for example, disposing the carbon-based anode in the battery housing may comprise disposing an anode comprising at least one of graphite, hard carbon, mesophase microbeads, or any combination thereof in the housing.

In accordance with certain embodiments, for instance, disposing the electrolyte in the battery housing may comprise disposing an electrolyte having a lithium ion source concentration of 1.0 to 3.5 M in the housing. In some embodiments, for example, disposing the electrolyte in the battery housing may comprise disposing an electrolyte in the battery housing wherein the lithium ion source comprises at least one of a phosphate, a borate or boron-based cluster, an imide, a heterocyclic anion, an aluminate, or any combination thereof.

In accordance with certain embodiments, for instance, disposing the electrolyte in the battery housing may comprise disposing an electrolyte having an inorganic salt concentration of 0.4 to 1.5 M in the housing. In some embodiments, for example, disposing the electrolyte in the battery housing may comprise disposing an electrolyte in the battery housing wherein the inorganic salt comprises at least one of a nitrate salt, a sulfate salt, a phosphate salt, a carbonate salt, or any combination thereof. In further embodiments, for instance, disposing the electrolyte in the battery housing may comprise disposing an electrolyte in the battery housing wherein the inorganic salt comprises at least one of LiNO₃, NaNO₃, Li₂SO₄, or any combination thereof.

In accordance with certain embodiments, for example, disposing the electrolyte in the battery housing may comprise disposing an electrolyte having 1.5 M lithium ion source and 1.5 M inorganic salt in the housing. In other embodiments, for instance, disposing the electrolyte in the battery housing may comprise disposing an electrolyte having 2.5 M lithium ion source and 0.4 M inorganic salt in the housing. In further embodiments, for example, disposing the electrolyte in the battery housing may comprise disposing an electrolyte having 1.0 M lithium ion source and 0.4 M inorganic salt in the housing.

In accordance with certain embodiments, for instance, disposing the electrolyte in the battery housing may comprise disposing an electrolyte in the battery housing wherein the electrolyte solvent comprises at least one of an ether-based solvent, a sulfone, a sulfoxide nitrile, a phosphorous-based solvent, a silicon-based solvent, or any combination thereof. In some embodiments, for example, disposing the electrolyte in the battery housing may comprise disposing an electrolyte in the battery housing wherein the ether-based solvent comprises at least one of dioxolane, dimethoxyethane, tetrahydrofuran, diethyl ether, tetraethylene glycol dimethyl ether, or any combination thereof.

Many modifications and other embodiments of the inventions set forth herein will come to mind to one skilled in the art to which the inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An electrolyte configured for use in a lithium battery, the electrolyte comprising:
a lithium ion source;
an electrolyte solvent; and
an inorganic salt represented by the formula MA, wherein:
M is selected from the group consisting of Li⁺, Na⁺, K⁺, Ca²⁺, Mg²⁺, and Al³⁺, and
A is selected from the group consisting of F⁻, Cl⁻, Br⁻, I⁻, NO₃⁻, SO₄²⁻, CO₃²⁻, and PO₄³⁻,
wherein the inorganic salt provides coordination cores for lithium ion aggregation.

2. The electrolyte according to claim 1, wherein the electrolyte comprises a lithium ion source concentration of 1.0 to 3.5 M.

3. The electrolyte according to claim 1, wherein the electrolyte comprises an inorganic salt concentration of 0.4 to 1.5 M.

4-6. (canceled)

7. The electrolyte according to claim 1, wherein the lithium ion source comprises at least one of a phosphate, a borate or boron-based cluster, an imide, a heterocyclic anion, an aluminate, or any combination thereof.

8. The electrolyte according to claim 1, wherein the electrolyte solvent comprises at least one of an ether-based solvent, a sulfone, a sulfoxide nitrile, a phosphorous-based solvent, a silicon-based solvent, or any combination thereof.

9. The electrolyte according to claim 8, wherein the ether-based solvent comprises at least one of dioxolane, dimethoxyethane, tetrahydrofuran, diethyl ether, tetraethylene glycol dimethyl ether, or any combination thereof.

10. The electrolyte according to claim 1, wherein the inorganic salt comprises at least one of a nitrate salt, a sulfate salt, a phosphate salt, a carbonate salt, or any combination thereof.

11-20. (canceled)

21. A lithium battery comprising:
a cathode;
a carbon-based anode; and
an electrolyte, the electrolyte comprising:
a lithium ion source,
an electrolyte solvent, and
an inorganic salt represented by the formula MA, wherein:
M is selected from the group consisting of Li⁺, Na⁺, K⁺, Ca²⁺, Mg²⁺, and Al³⁺, and
A is selected from the group consisting of F⁻, Cl⁻, Br⁻, I⁻, NO₃⁻, SO₄²⁻, CO₃²⁻, and PO₄³⁻,
wherein the inorganic salt provides coordination cores for lithium ion aggregation.

22. The lithium battery according to claim 21, wherein the cathode is a lithium-based cathode.

23. The lithium battery according to claim 21, wherein the cathode comprises sulfur.

24. The lithium battery according to claim 21, wherein the cathode comprises oxygen.

25. The lithium battery according to claim 21, wherein the carbon-based anode comprises at least one of graphite, hard carbon, mesophase microbeads, or any combination thereof.

26-39. (canceled)

40. A method of preparing a stable lithium battery, the method comprising:
disposing a cathode in a housing;
disposing a carbon-based anode in the battery housing in fixed relation to the cathode; and
disposing an electrolyte in the battery housing between the cathode and the anode, the electrolyte comprising:
a lithium ion source,
an electrolyte solvent, and
an inorganic salt represented by the formula MA, wherein:
M is selected from the group consisting of Li⁺, Na⁺, K⁺, Ca²⁺, Mg²⁺, and Al³⁺, and
A is selected from the group consisting of F⁻, Cl⁻, Br⁻, I⁻, NO₃⁻, SO₄²⁻, O₃²⁻, and PO₄³⁺,
wherein the inorganic salt provides coordination cores for lithium ion aggregation.

41. The method according to claim 40, wherein disposing the cathode in the battery housing comprises disposing a lithium-based cathode in the housing.

42. The method according to claim 40, wherein disposing the cathode in the battery housing comprises disposing a cathode comprising sulfur in the housing.

43. The method according to claim 40, wherein disposing the cathode in the battery housing comprises disposing a cathode comprising oxygen in the housing.

44. The method according to claim 40, wherein disposing the carbon-based anode in the battery housing comprises disposing an anode comprising at least one of graphite, hard carbon, mesophase microbeads, or any combination thereof in the housing.

45-55. (canceled)
